(19) United States
(12) Patent Application Publication
(10) Pub. No.: US 2023/0384968 A1
(43) Pub. Date: Nov. 30, 2023

(54) STORAGE DEVICE, STORAGE CONTROL METHOD, AND COMPUTER-READABLE RECORDING MEDIUM STORING STORAGE CONTROL PROGRAM

(71) Applicant: Fujitsu Limited, Kawasaki-shi (JP)

(72) Inventors: Keima ABE, Kawasaki (JP); Hidejirou DAIKOKUYA, Kawasaki (JP)

(73) Assignee: Fujitsu Limited, Kawasaki-shi (JP)

(21) Appl. No.: 18/168,384

(22) Filed: Feb. 13, 2023

(30) Foreign Application Priority Data
May 31, 2022 (JP) 2022-088441

(51) Int. Cl. G06F 3/06

(52) U.S. Cl. CPC G06F 3/0655; G06F 3/0638; G06F 3/067

(57) ABSTRACT

A storage device comprising a storage including a first pool area providing a physical area in units of first chunks of first size, and a second pool area providing a physical area in units of second chunks of second size smaller than the first size, and a controller. The controller counts a first count value indicating a number of first divided areas in which data is stored from among a plurality of the first divided areas obtained by dividing, by the second size, a virtual volume that has the first chunk allocated only to an area in which data is stored. In a case where a ratio of the first count value to a number of the first chunks allocated to the virtual volume is equal to or less than a first threshold, allocate the second chunk instead of the first chunk to the virtual volume.

### CROSS-REFERENCE TO RELATED APPLICATION

This application is based upon and claims the benefit of priority of the prior Japanese Patent Application No. 2022-88441, filed on May 31, 2022, the entire contents of which are incorporated herein by reference.

### FIELD

The embodiments discussed herein are related to a storage device, a storage control method, and a storage control program.

### BACKGROUND

Thin provisioning is a technique that enables efficient use of physical storage areas by virtualizing storage capacity. In this technique, a virtual volume, which is a virtual storage area, is created as a user's access target. Then, the physical storage areas are dynamically allocated only to the storage areas in which data is written among the storage areas of the virtual volume.

As a technique related to virtual volumes, for example, a storage device has been proposed, which analyzes an access status to data of the virtual volume and resets the management unit of the storage area in the virtual volume such that the management unit becomes optimal for the access status.

Japanese Laid-open Patent Publication No. 2008-269338 is disclosed as related art.

### SUMMARY

According to an aspect of the embodiments, a storage device includes a storage in which a first pool area that provides a physical storage area in units of first chunks of a first size, and a second pool area that provides a physical storage area in units of second chunks of a second size smaller than the first size are set; and a controller including a processor configured to count a first count value that indicates a number of first divided areas in which data is stored from among a plurality of the first divided areas obtained by dividing, for the each second size, a virtual volume that has the first chunk allocated only to an area in which data is stored from the first pool area, and in a case where a ratio or an increase amount of the first count value to a number of the first chunks allocated to the virtual volume is equal to or less than a first threshold, allocate the second chunk from the second pool area instead of the first chunk to the virtual volume and move the data of the first chunk allocated to the virtual volume to the second chunk allocated to the virtual volume.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of a storage device according to a first embodiment;

FIG. 2 is a diagram illustrating a configuration example of a storage system according to a second embodiment;

FIG. 3 is a diagram illustrating a configuration example of processing functions of a controller module (CM);

FIG. 4 is a diagram illustrating a data configuration example of thin provisioning management information;

FIG. 5 is a diagram illustrating a chunk allocation example from thin provisioning pools (TPPs) to thin provisioning volumes (TPVs);

FIG. 6 is a diagram for describing migration processing by a thin provisioning control unit;

FIGS. 7A and 7B are diagrams illustrating cases where it is better to change a chunk size;

FIG. 8 is a diagram illustrating a determination processing example as to necessity of migration to a TPP with a large chunk size;

FIG. 9 is a diagram illustrating a determination processing example as to necessity of migration to a TPP with a small chunk size;

FIG. 10 is an example of a flowchart illustrating a procedure of migration control processing;

FIG. 11 is an example of a flowchart illustrating a procedure of first migration determination processing;

FIG. 12 is an example of a flowchart illustrating a procedure of migration processing to a TPP with a large chunk size;

FIG. 13 is an example of a flowchart illustrating a procedure of second migration determination processing;

FIG. 14 is an example of a flowchart illustrating a procedure of migration processing to a TPP with a small chunk size; and

FIG. 15 is a flowchart illustrating a procedure of 0 reclamation processing.

### DESCRIPTION OF EMBODIMENTS

A physical storage area is dynamically allocated to a virtual volume in units of fixed-size areas called chunks. A chunk size is fixedly set in a pool area that provides the physical storage area for the virtual volume.

Regarding the chunk size, basically, the smaller the chunk size, the higher the use efficiency of the physical storage area. For example, in a case where a write that specifies a small-size write destination area is requested and if a large-size chunk is allocated, data is written only to a partial area of the chunk, and a wasted area that does not include valid data is generated in the chunk. The smaller the chunk size, the less likely this kind of wasted area will occur.

On the other hand, the smaller the chunk size, the greater the number of chunks prepared in the pool area and the number of chunks allocated to the virtual volume. Therefore, there is a problem that the storage area for storing management information for managing chunks becomes large.

In this way, regarding chunk allocation to virtual volumes, there is a problem that it is difficult to allocate chunks from a pool area with an optimal chunk size that increases the use efficiency of the physical area and reduces storage capacity of the management information.

In one aspect, an object of the present embodiments is to provide a storage device, a storage control method, and a storage control program capable of optimizing the size of chunks to be allocated to virtual volumes. Hereinafter, embodiments will be described with reference to the drawings.

### First Embodiment

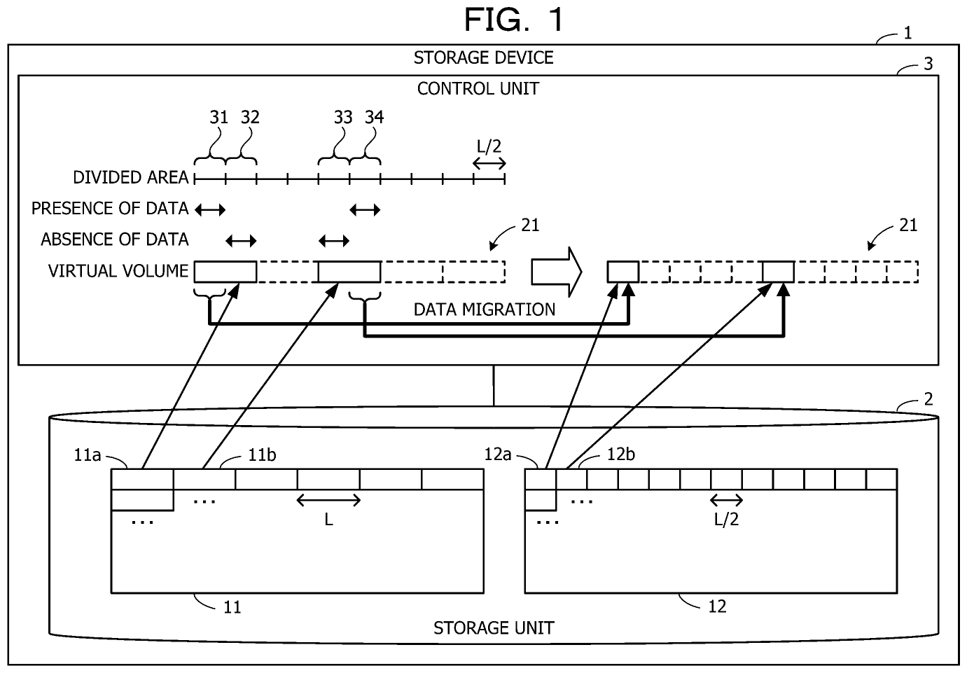

FIG. 1 is a diagram illustrating a configuration example and a processing example of a storage device according to a first embodiment. A storage device 1 illustrated in FIG. 1 has a storage unit 2 and a control unit 3. The storage unit 2 is a physical storage area secured in one or a plurality of storage devices. The control unit 3 is, for example, a processor.

In the storage unit 2, a pool area 11 that provides physical storage areas in units of chunks having a first size, and a pool area 12 that provides physical storage areas in units of chunks having a second size smaller than the first size are set. In FIG. 1, as an example, it is assumed that the pool area 11 has a chunk size of L and the pool area 12 has a chunk size of L/2.

Furthermore, in the storage device 1, a virtual volume can be set, and chunks can be dynamically allocated from either the pool area 11 or 12 to the virtual volume. In the virtual volume, chunks are allocated only to areas to which data write is requested, and data is written to the chunks. In FIG. 1, a virtual volume 21 is set as an example. The virtual volume 21 has a capacity corresponding to five chunks of the pool area 11, but it is assumed that only two chunks 11a and 11b are allocated from the pool area 11.

By the way, regarding a chunk size, basically, the smaller the chunk size, the higher the use efficiency of the physical storage area. Therefore, changing an allocation source that allocates chunks to the virtual volume 21 from the pool area 11 to the pool area 12 with a smaller chunk size is more likely to improve use efficiency of the physical storage area. On the other hand, the smaller the chunk size, the larger the number of chunks prepared in the pool area and the number of chunks allocated to the virtual volume. Therefore, there is a problem that a storage area for storing management information for managing chunks becomes large.

In a case of determining that the chunk size of the pool area 12 is more appropriate than the chunk size of the pool area 11 based on a chunk allocation status and a data storage status in the virtual volume 21, the control unit 3 changes the allocation source of chunks to the pool area 12. For example, the control unit 3 executes the following processing.

The control unit 3 divides the virtual volume 21 for each chunk size of the pool area 12. The control unit 3 counts a count value indicating the number of divided areas in which data is stored, among a plurality of divided areas generated by division. Then, the control unit 3 calculates a ratio or an increase amount of the above count value to the number of chunks allocated from the pool area 11 to the virtual volume 21.

The above count value indicates an estimated value of the number of chunks allocated from the pool area 12 to the virtual volume 21 in a case where the allocation source of chunks is changed to the pool area 12. Therefore, the calculated ratio indicates how much rate the number of chunks allocated to the virtual volume 21 will increase in the case where the allocation source of chunks is changed to the pool area 12. Furthermore, the calculated increase amount indicates how much the number of chunks allocated to the virtual volume 21 increases in the case where the allocation source of chunks is changed to the pool area 12.

Therefore, the control unit 3 changes the allocation source of chunks to the pool area 12 in a case where the calculated ratio or increase amount is equal to or less than a predetermined threshold. Thereby, it is possible to improve the use efficiency of the physical storage area while suppressing an increase in the number of allocations of chunks.

In the example of FIG. 1, the chunk 11a is allocated to a range of divided areas 31 and 32 in the virtual volume 21, and the chunk 11b is allocated to a range of divided areas 33 and 34. Note that data is stored in the range of the divided area 31 in the chunk 11a, but no data is stored in the range of the divided area 32. Furthermore, data is stored in the range of the divided area 34 in the chunk 11b, but no data is stored in the range of the divided area 33. Since the data is stored in the two divided areas 31 and 34 in this manner, the control unit 3 counts the above count value as “2”.

Furthermore, the number of chunks allocated from the pool area 11 to the virtual volume 21 is “2”. Therefore, the control unit 3 calculates the ratio as 100% and the increase amount as “0”. For the purpose of suppressing an increase in the number of allocations of chunks, the threshold for the ratio is set to be greater than 100%, and the threshold for the increase amount is set to “1” or more. Therefore, in the example of FIG. 1, both the calculated ratio and increase amount are equal to or less than the threshold, so the control unit 3 changes the allocation source of chunks to the virtual volume 21 from the pool area 11 to the pool area 12.

In this case, the control unit 3 allocates chunks of the pool area 12 instead of chunks of the pool area 11 to the virtual volume 21. Then, the control unit 3 moves chunk data allocated from the pool area 11 to the virtual volume 21 to the chunks allocated from the pool area 12. In the example of FIG. 1, the control unit 3 allocates chunks 12a and 12b of the pool area 12 to the virtual volume 21. Then, the control unit 3 moves the data in the range of the divided area 31 in the chunk 11a to the chunk 12a, and moves the data in the range of the divided area 34 in the chunk 11b to the chunk 12b.

In this way, the control unit 3 can change the allocation source of chunks to the virtual volume to the pool area with a smaller chunk size in the case where it is estimated that the use efficiency of the physical storage area can be improved while suppressing an increase in the number of allocations of chunks. Therefore, the size of chunks allocated to the virtual volume can be optimized.

### Second Embodiment

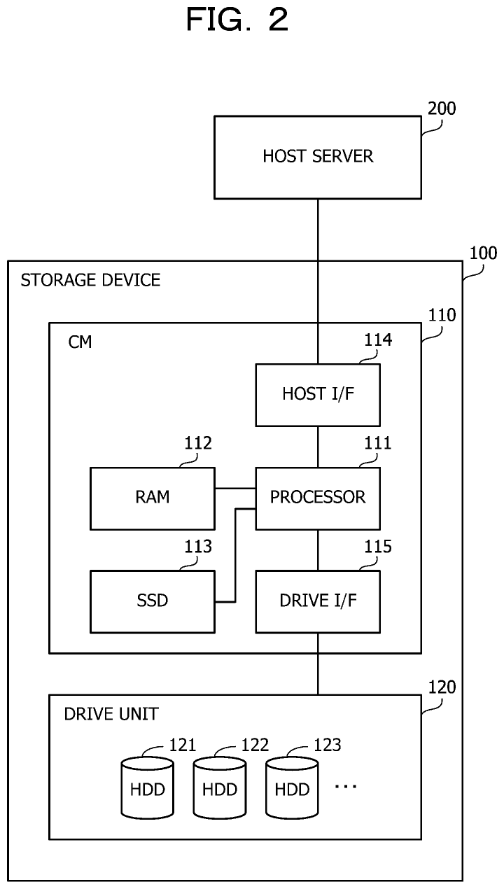

FIG. 2 is a diagram illustrating a configuration example of a storage system according to a second embodiment. A storage system illustrated in FIG. 2 includes a storage device 100 and a host server 200. The storage device 100 includes a controller module (CM) 110 and a drive unit 120.

The CM 110 is coupled with the host server 200 via a storage area network (SAN) using, for example, a fibre channel (FC), an Internet small computer system interface (iSCSI), or the like. The CM 110 is a storage control device that controls access to a storage device mounted in the drive unit 120 in response to a request sent from the host server 200. Note that the CM 110 is an example of the storage control device 10 illustrated in FIG. 1.

In the drive unit 120, a plurality of storage devices to be accessed from the host server 200 is mounted. In the present embodiment, as an example, the drive unit 120 is a disk array device in which hard disk drives (HDDs) 121, 122, 123, and so on are mounted as the storage devices. Note that another type of nonvolatile storage device, such as a solid-state drive (SSD) may be used as the storage device.

The host server 200 is a server device that executes various types of processing such as business processing, for example. The host server 200 accesses the storage area provided by the storage device 100 in accordance with the execution of such processing. For example, the CM 110 generates a logical volume (logical storage area) using an HDD in the drive unit 120, and the host server 210 accesses the HDD in the drive unit 120 by sending a request for accessing the logical volume to the CM 110. As will be described below, such a logical volume is generated as a virtual volume using thin provisioning. Note that a plurality of the host servers 200 may be coupled to CM 110.

Here, a hardware configuration example of the CM 110 will be described with reference to FIG. 2. The CM 110 includes a processor 111, a random-access memory (RAM) 112, an SSD 113, a host interface (I/F) 114, and a drive interface (I/F) 115.

The processor 111 integrally controls the entire CM 110. The processor 111 may be a multiprocessor. The processor 111 is, for example, a central processing unit (CPU), a micro processing unit (MPU), a digital signal processor (DSP), an application specific integrated circuit (ASIC), or a programmable logic device (PLD). Furthermore, the processor 111 may be a combination of two or more elements of the CPU, MPU, DSP, ASIC, and PLD.

The RAM 112 is used as a main storage device of the CM 110. The RAM 112 temporarily stores at least some of operating system (OS) programs and application programs to be executed by the processor 111. The SSD 113 is used as an auxiliary storage device of the CM 110. The SSD 113 stores an OS program, an application program, and various data.

The host interface 114 is a communication interface for communicating with the host server 200. The drive interface 115 is a communication interface for communicating with the drive unit 120. The drive interface 115 is, for example, a serial attached SCSI (SAS) interface.

Processing functions of the CM 110 are implemented by the above hardware configuration.

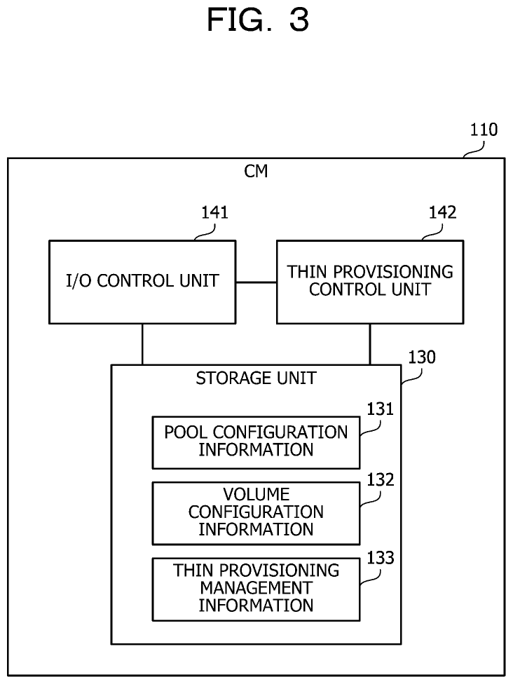

FIG. 3 is a diagram illustrating a configuration example of the processing functions of the CM. As illustrated in FIG. 3, the CM 110 includes a storage unit 130, an input/output (I/O) control unit 141, and a thin provisioning control unit 142.

The storage unit 130 is a storage area secured in a storage device provided in the CM 110, such as the RAM 112 or the SSD 113. The storage unit 130 stores pool configuration information 131, volume configuration information 132, and thin provisioning management information 133.

In the CM 110, a virtual volume to be accessed from the host server 200 is created. In the virtual volume, a physical area is allocated from the storage pool only to an area in which data has been written in response to a request from the host server 200. A storage pool is a physical storage area implemented using a plurality of HDDs mounted in the drive unit 120 and shared by one or more virtual volumes.

In the following description, the virtual volume is described as thin provisioning volume (TPV), and the storage pool is described as thin provisioning pool (TPP).

The pool configuration information 131 is information indicating the configuration of the TPP. For example, the pool configuration information 131 includes information such as identification information of the TPP, identification information of an HDD belonging to the TPP, the capacity of the TPP, and the size of chunks in the TPP. Note that a chunk is a physical area of a fixed size that serves as an allocation unit for the TPV.

The volume configuration information 132 is information indicating the configuration of the TPV. For example, the volume configuration information 132 includes information such as identification information of the TPV and the size of the TPV.

The thin provisioning management information 133 is information indicating a correspondence relationship between the storage area of the TPV and the chunks allocated from the TPP to the storage area of the TPV.

The processing of the I/O control unit 141 and the thin provisioning control unit 142 are implemented by the processor 111 executing a predetermined application program, for example.

The I/O control unit 141 controls I/O processing for the TPV in response to a request from the host server 200. The thin provisioning control unit 142 controls allocation of chunks from the TPP to the TPV.

For example, when receiving a data write I/O request for a write destination area in the TPV from the host server 200, the I/O control unit 141 determines whether a chunk is allocated to the write destination area based on the thin provisioning management information 133. In a case where a chunk is allocated, the I/O control unit 141 writes write data to the allocated chunk and transmits a completion response to the host server 200. On the other hand, in a case where no chunk is allocated, the thin provisioning control unit 142 selects an unallocated chunk from the TPP and allocates that chunk to the write destination area. The I/O control unit 141 writes the write data to the allocated chunk and transmits the completion response to the host server 200. Note that, in practice, the completion response may be sent at the point of time when the write data is written to a cache, and the write data may be written to the chunk at asynchronous timing thereafter.

Furthermore, the thin provisioning control unit 142 controls migration processing of the TPV to another TPP. In the present embodiment, “migration” refers to processing of changing the allocation source TPP of chunks for the TPV to another TPP and rearranging data of the TPV between the TPPs.

Furthermore, the thin provisioning control unit 142 writes data with a value of “0” (0 data) to chunks released from the TPV among the chunks of the TPP for the purpose of preventing data leakage. For example, the thin provisioning control unit 142 writes the 0 data to the chunks allocated to the TPV in a case where the host server 200 requests deletion of the TPV and further requests release (unmap) of the TPV, or in a case where the original TPV is released due to execution of migration.

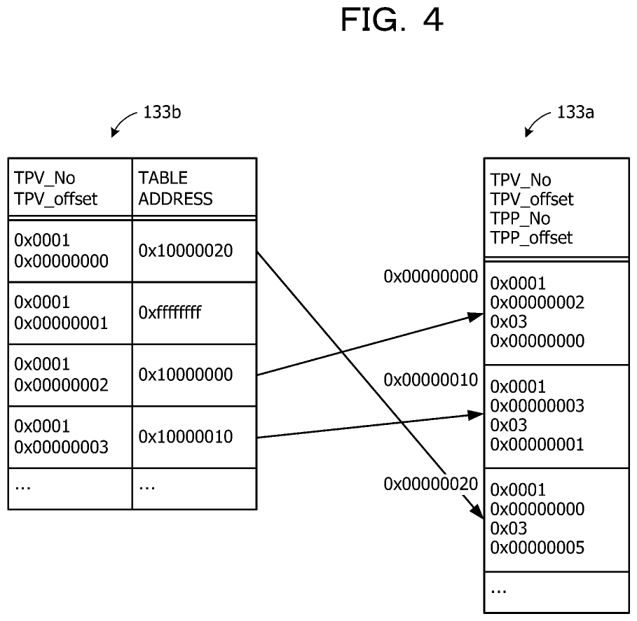

FIG. 4 is a diagram illustrating a data configuration example of the thin provisioning management information. As illustrated in FIG. 4, the thin provisioning management information 133 includes a mapping table 133a and an allocation information table 133b.

The mapping table 133a is a management table for managing a correspondence relationship between a chunk of the TPP and a divided area of the TPV that is the allocation destination of the chunk. A new record is added to the mapping table 133a when a chunk of a certain TPP is newly allocated to the divided area of the TPV. The divided area is an area obtained by dividing the TPV for each chunk size.

In each record, identification information of a chunk and identification information of a divided area in the TPV, which is an allocation destination of the chunk, are registered in association with each other. The identification information of the chunk is represented by TPP_No for identifying the TPP and TPP_offset for representing a head position of the chunk in the TPP by an offset amount (logical block address: LBA) from the head of the TPP. The identification information of the divided area in the TPV is represented by TPV_No for identifying the TPV and TPV_offset representing a head position of the divided area in the TPV by an offset amount (LBA) from the head of the TPV.

When a TPV is newly generated, a record corresponding to each divided area included in the TPV is added to the allocation information table 133b. In each record, the identification information of the divided area and a table address indicating an address of the record of the mapping table 133a are registered in association with each other. The identification information of the divided area is represented by TPV_No for identifying the TPV and TPV_offset for representing the head position of the divided area in the TPV by the offset amount (LBA) from the head of the TPV. By associating the table address of the mapping table 133a with such identification information of the divided area, it becomes possible to refer to the information of the chunk allocated to the divided area.

Note that in a case where no chunk is allocated to the divided area, an invalid value (“0xffffffff” in the example of FIG. 4) is registered as the table address. Therefore, at the point of time when a new TPV is generated, the invalid value is registered as an initial value of the table address in the record corresponding to each divided area of the TPV.

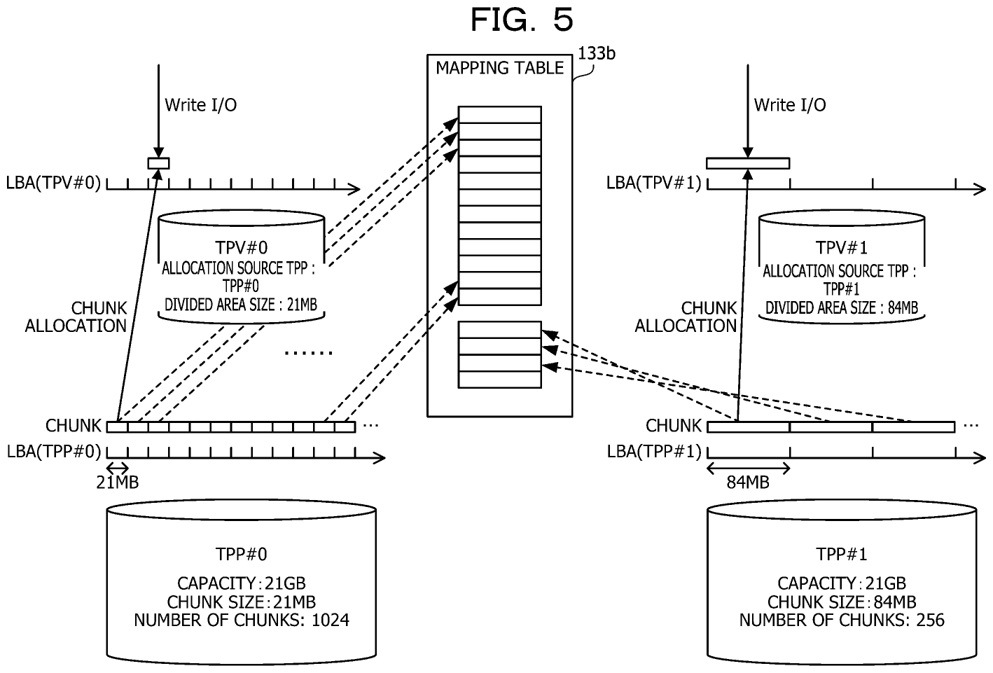

FIG. 5 is a diagram illustrating a chunk allocation example from TPPs to TPVs. In the storage device 100 of the present embodiment, the chunk size is fixedly set for the TPP, and a plurality of TPPs with different chunk sizes can be generated. FIG. 5 illustrates TPP#0 and TPP#1 having different chunk sizes from each other. TPP#0 is a storage pool with the capacity of 21 GB, the chunk size of 21 MB, and 1024 chunks. Meanwhile, TPP#1 is a storage pool with the capacity of 21 GB, the chunk size of 84 MB, and 256 chunks.

Furthermore, FIG. 5 illustrates TPV#0 having TPP#0 as the allocation source of chunks and TPV#1 having TPP#1 as the allocation source of chunks. A chunk is the allocation unit of a physical area for a TPV, so in a case where the chunk size of the TPP is different, the size of the divided area of the TPV, which is the allocation destination of the chunk, is also different.

For example, the size of the divided area that is the allocation unit of chunks in TPP#0 is 21 MB, which is the same as the chunk size of TPP#0. Therefore, for example, in a case where a write I/O to a certain write destination area (having a size equal to or less than the divided area here) in TPV#0 is requested from the host server 200, the chunk with 21 MB is allocated from TPP#0 to this write destination area, and write data is written to the chunk.

Similarly, the size of the divided area that is the allocation unit of chunks in TPP#1 is 84 MB, which is the same as the chunk size of TPP#1. Therefore, for example, in a case where a write I/O to a certain write destination area (having a size equal to or less than the divided area here) in TPV#1 is requested from the host server 200, the chunk with 84 MB is allocated from TPP#1 to this write destination area, and write data is written to the chunk.

Here, regarding the chunk size, basically, the smaller the chunk size, the higher the capacity efficiency (use efficiency of the physical area). For example, in a case where the write I/O that specifies a write destination area smaller than the chunk size is requested, the write data is written only to part of the allocated chunk, and the remaining area of the chunk becomes in an unused state. Since such a case is more likely to occur as the chunk size increases, it can be said that the smaller the chunk size, the higher the capacity efficiency.

Meanwhile, if the TPP capacity is the same, the smaller the chunk size, the larger the number of chunks. Furthermore, as illustrated in FIG. 4, a record for each chunk or divided area is registered in the management table in the thin provisioning management information 133. For example, a record corresponding to each divided area of the TPV is registered in the allocation information table 133b, and a record corresponding to each chunk allocated to the divided area is registered in the mapping table 133a. Therefore, the smaller the chunk size, the larger the number of records to be registered and the larger the capacity of the management table.

As the capacity of the management table increases, the capacity of the required storage area also increases and device cost increases. For example, in a case where the management table is stored in the RAM for improving access speed, the required capacity of the RAM increases. Furthermore, in a case where the RAM is also used as a cache for I/O processing, the larger the capacity of the management table, the smaller the capacity that can be used as a cache, resulting in a decrease in I/O response performance.

Thus, there are advantages and disadvantages depending on the magnitude of the chunk size. It is desirable to minimize the disadvantage while maximizing the above advantage by selecting an appropriate chunk size according to an I/O environment of the TPV as the size of the chunk to be allocated to the TPV.

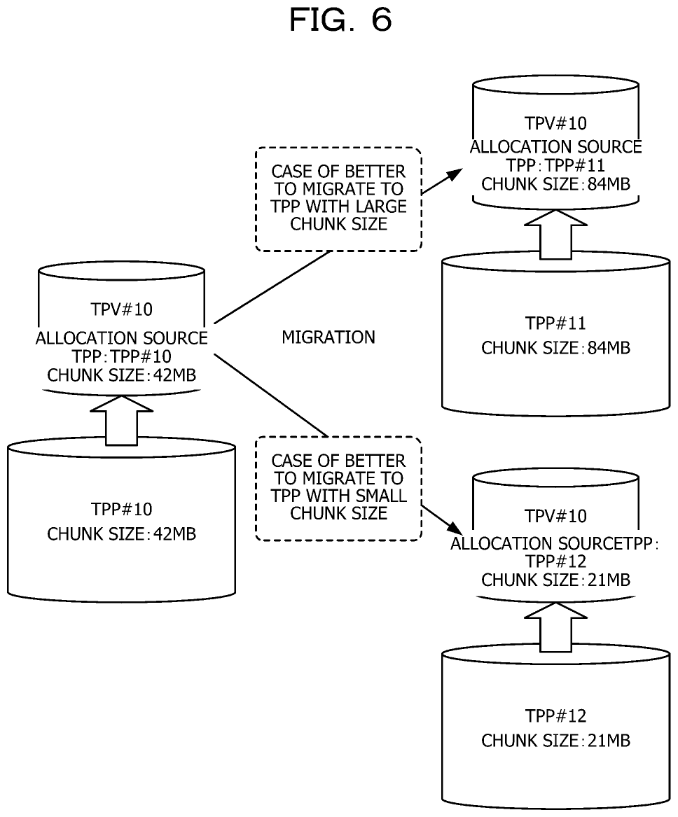

FIG. 6 is a diagram for describing migration processing by the thin provisioning control unit. In the present embodiment, thin provisioning control unit 142 adaptively migrates the TPV to another TPP with a larger chunk size or to another TPP with a smaller chunk size than the allocation source TPP that currently allocates chunks to the TPV.

As an example in FIG. 6, TPP#10 with the chunk size of 42 MB is the allocation source TPP for TPV#10. Furthermore, it is assumed that TPP#11 with the chunk size of 84 MB and TPP#12 with the chunk size of 21 MB are generated in addition to TPP#10. In this status, the thin provisioning control unit 142 determines whether to change the chunk allocation source TPP for TPV#10 to the TPP with a larger chunk size or the TPP with a smaller chunk size.

In the former case, the thin provisioning control unit 142 allocates a new chunk from TPP#11 to a data storage area in TPV#10, and moves the original chunk data allocated to TPV#10 to the new chunk. Meanwhile, in the latter case, the thin provisioning control unit 142 allocates a new chunk from TPP#12 to the data storage area in TPV#10, and moves the original chunk data allocated to TPV#10 to the new chunk.

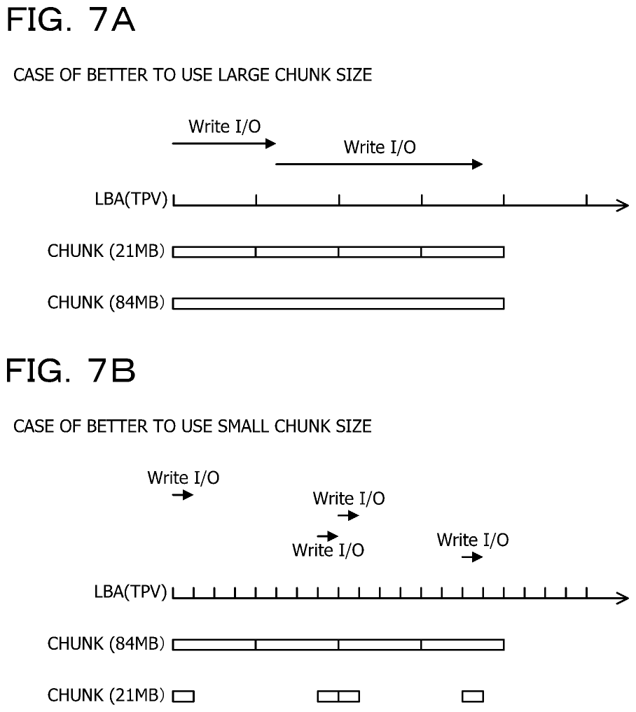

Here, as illustrated in next FIGS. 7A and 7B, cases where it is better to use a large chunk size and cases where it is better to use a small chunk size depending on a write I/O occurrence status are conceivable.

FIGS. 7A and 7B are diagrams illustrating cases where it is better to change the chunk size. FIG. 7A illustrates a case where it is better to use a large chunk size, and FIG. 7B illustrates a case where it is better to use a small chunk size. Note that, in FIGS. 7A and 7B, as an example, a case of allocating a chunk of 21 MB is compared with a case of allocating a chunk of 84 MB.

FIG. 7A illustrates a case in which many sequential write I/Os with write data having a relatively large size occur. In this case, data is written to a relatively large contiguous area over the TPV. In this case, even if the large-sized chunk is allocated to the TPV, it is unlikely that a wasted area with no data written is generated over the chunk. Conversely, if small-sized chunks are allocated to the TPV, the number of allocated chunks increases and the number of records in the management table increases.

In the example of FIG. 7A, only one chunk of 84 MB is allocated, whereas four chunks of 21 MB are allocated, for two write I/Os. In both cases, the size of an area where no data is written on the chunk is the same, and there is no difference in the capacity efficiency. However, the number of allocations of chunks is greater in the case of using the chunks of 21 MB, which increases the number of records in the management table, thus requiring a larger storage area for the management table. Therefore, it is considered better to use a large chunk size in such cases.

Meanwhile, FIG. 7B illustrates a case in which many random write I/Os with relatively small-size write data occur. In this case, small-size data is written to discrete locations over the TPV. In this case, if a chunk with a large size is allocated to the TPV, a large area with no data written is more likely to occur over the chunk. For this reason, the capacity efficiency is lower than the case of allocating small-size chunks.

In the example of FIG. 7B, four chunks are allocated for four write I/Os in both cases of using the chunks of 21 MB chunks and using the chunks of 84 MB. Therefore, there is no difference in the number of records in the management table. However, since the write data is written only to a partial area in any chunk of 84 MB, the capacity efficiency is low. Therefore, it is considered better to use a smaller chunk size in such cases.

Such a difference in write I/O occurrence status may occur due to, for example, a difference in use and applications of TPV. For example, random writes of small write data tend to occur in database applications, and sequential writes of large write data tend to occur in multimedia data storage applications.

However, it is difficult for the CM 110 side to recognize such use and applications of TPV. Furthermore, for example, in a case where the CM 110 analyzes the write I/O occurrence status as described above, there is a problem that a processing load on the CM 110 increases. When the processing load on the CM 110 increases, there is a possibility that the response performance to I/O requests will be lowered. Furthermore, to maintain the response performance to I/O requests, processing performance of the CM 110 needs to be improved, which increases the device cost.

Therefore, in the present embodiment, the thin provisioning control unit 142 periodically monitors the allocation status of chunks and the write status of data to the TPV. The thin provisioning control unit 142 determines whether to migrate to the TPP with a larger chunk size or to the TPP with a smaller chunk size based on monitoring results, and executes migration in a case of determining to migrate. The determination processing load can be reduced by determining necessity of migration based on the allocation status of chunks and the write status of data at determination time rather than analyzing the write I/O occurrence status in a temporally continuous period.

In the following description, the TPP as the chunk allocation source before change (the current TPP as the chunk allocation source) for the TPV to be determined is described as “migration source TPP”, and the TPP as the chunk allocation source after change is described as “migration destination TPP”.

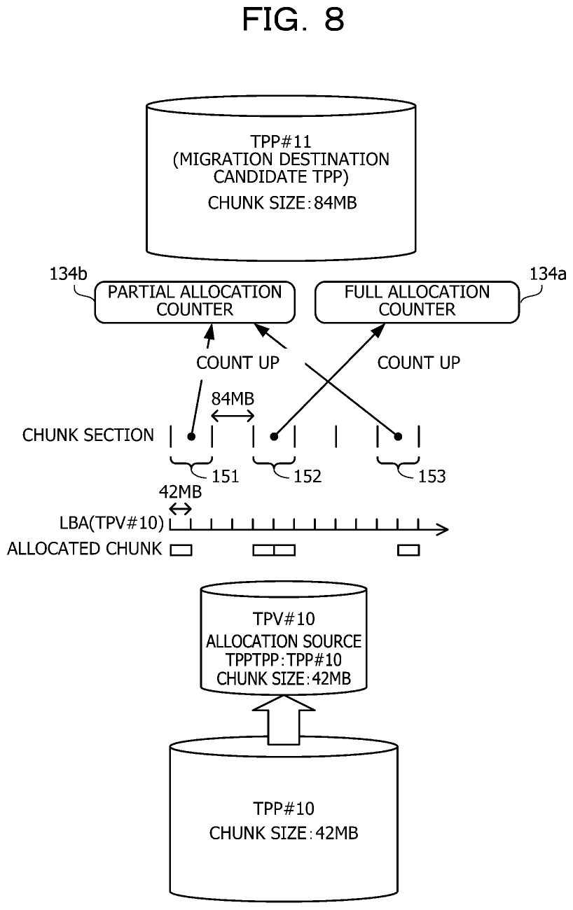

FIG. 8 is a diagram illustrating a determination processing example as to necessity of migration to the TPP with a large chunk size. The thin provisioning control unit 142 determines whether to migrate the TPV to be determined to the TPP with a larger chunk size by the following procedure.

First, the thin provisioning control unit 142 determines whether there is a TPP that satisfies all of the following determination conditions (1-1) to (1-4) in addition to the migration source TPP for the TPV to be determined.

The determination condition (1-1): The chunk size is larger than the chunk size of the migration source TPP.

The determination condition (1-2): The chunk size is a multiple of the chunk size of the migration source TPP.

The determination condition (1-3): There is sufficient free space (number of unallocated chunks).

The determination condition (1-4): A user of the TPV to be determined as a migration destination permits the migration in advance.

The determination condition (1-2) is a condition for enabling determination as to the necessity of migration using a full allocation counter 134a and a partial allocation counter 134b, which will be described below. The determination condition (1-3) is a condition indicating that the capacity of the migration destination TPP will not be depleted even after migration, and is satisfied in a case where, for example, the free space of the migration destination TPP is equal to or greater than the capacity of the TPV to be determined. The determination condition (1-4) is determined based on, for example, preset information.

In a case where there are other TPPs that satisfy all the above determination conditions (1-1) to (1-4), the thin provisioning control unit 142 selects the TPP with the chunk size closest to the chunk size of the migration source TPP (for example, the TPP with the smallest chunk size) as a migration destination candidate TPP.

Next, the thin provisioning control unit 142 determines the allocation status of chunks and the write status of data to the TPV to be determined using the full allocation counter 134a and the partial allocation counter 134b.

In this processing, first, the thin provisioning control unit 142 divides the logical storage area of the TPV to be determined for each chunk size of the migration destination candidate TPP. Hereinafter, the divided areas are referred to as “chunk sections”. For example, in a case where the chunk size of the migration destination candidate TPP is three times the chunk size of the migration source TPP, each chunk section has the length of three chunks of the migration source TPP.

As an example in FIG. 8, chunks are allocated from TPP#10 with the chunk size of 42 MB to TPV#10 to be determined. Furthermore, it is assumed that TPP#11 with the chunk size of 84 MB is selected as the migration destination candidate TPP for such a migration source TPP#10. Since the chunk size of TPP#11 as the migration destination candidate is twice the chunk size of TPP#10 as the migration source, the chunk section over TPV#10 has the length of two chunks of TPP#10 as the migration source.

Next, the thin provisioning control unit 142 determines whether to count up the full allocation counter 134a and the partial allocation counter 134b for each chunk section of the TPV to be determined.

For example, the thin provisioning control unit 142 counts up the full allocation counter 134a in a case where chunks are allocated from the migration source TPP to the entire chunk section. For example, the full allocation counter 134a is counted up in a case where two chunks are allocated to the chunk section, assuming that the chunk size of the migration destination candidate TPP is twice the chunk size of the migration source TPP, as illustrated in FIG. 8. In the example of FIG. 8, two chunks have already been allocated to a chunk section 152, so the full allocation counter 134a in the chunk section 152 is counted up.

Furthermore, the thin provisioning control unit 142 counts up the partial allocation counter 134b in a case where chunks are allocated from the migration source TPP only to part of the chunk section. For example, the partial allocation counter 134b is counted up in a case where one chunk is allocated to the chunk section, assuming that the chunk size of the migration destination candidate TPP is twice the chunk size of the migration source TPP, as illustrated in FIG. 8. In the example of FIG. 8, one chunk has already been allocated to each of chunk sections 151 and 153, so the partial allocation counter 134b in the chunk sections 151 and 153 is counted up.

Next, the thin provisioning control unit 142 calculates a ratio R1 of chunk sections having chunks allocated entirely from the migration source TPP among chunk sections to which one or more chunks are allocated from the migration source TPP included in the TPV to be determined. The ratio R1 is calculated using the following equation (1), where the count value of the full allocation counter 134a is all_alloc_cnt and the count value of the partial allocation counter 134b is part_alloc_cnt:

R1[%]=all_alloc_cnt/(part_alloc_cnt+all_alloc_cnt)×100 (1)

The larger the above ratio R1, the less likely there will be wasted area where valid data is not written in the newly allocated chunks when migration to the migration destination candidate TPP is performed, and the increased capacity of the newly used physical area is also suppressed. For this reason, the effect of reducing the capacity of the management table is obtained while the decrease in the capacity efficiency after the execution of migration is suppressed. Therefore, in a case where the calculated ratio R1 is equal to or greater than a predetermined threshold (for example, 90%), the thin provisioning control unit 142 executes migration of the TPV to be determined to the migration destination candidate TPP as the migration destination.

Note that, in the above processing, he TPP with the chunk size closest to the chunk size of the migration source TPP (the TPP with the smallest chunk size) has been selected as the migration destination candidate TPP among other TPPs that satisfy all the determination conditions (1-1) to (1-4). However, another TPP with a larger chunk size may be selected. Note that, in this case, the full allocation counter 134a is less likely to be counted up, and the ratio R1 is less likely to be equal to or greater than the threshold. As a result, the TPV to be determined is less likely to be migrated to the TPP with a larger chunk size.

Meanwhile, by selecting another TPP with the smallest chunk size, it is possible to gradually migrate the TPV to the TPP with a larger chunk size, and a chunk with a size suitable for the data write status of the TPV is allocated. As a result, it is possible to optimize balance between improvement of a use rate of the physical area and reduction of storage capacity of the management table.

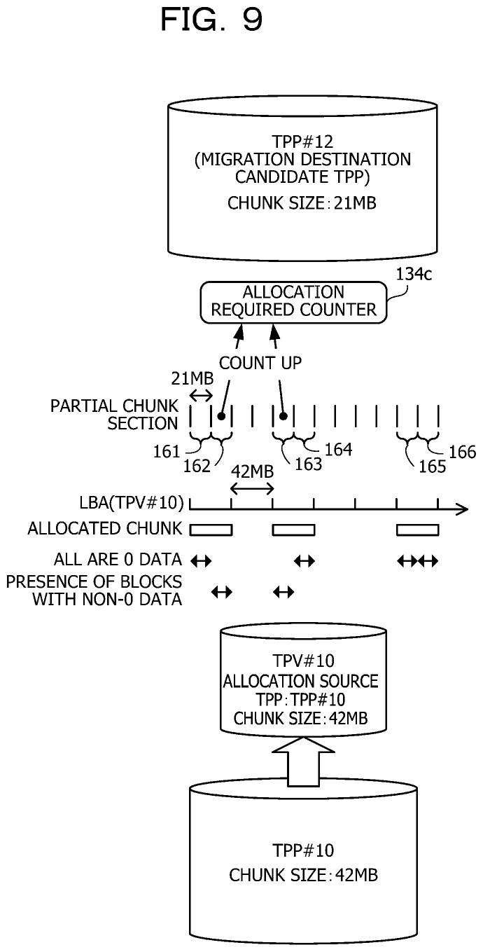

FIG. 9 is a diagram illustrating a determination processing example as to necessity of migration to the TPP with a small chunk size. The thin provisioning control unit 142 determines whether to migrate the TPV to be determined to the TPP with a smaller chunk size by the following procedure.

First, the thin provisioning control unit 142 determines whether there is a TPP that satisfies all of the following determination conditions (2-1) to (2-4) in addition to the migration source TPP for the TPV to be determined.

The determination condition (2-1): The chunk size is smaller than the chunk size of the migration source TPP.

The determination condition (2-2): The chunk size of the migration source TPP is a multiple of the chunk size of the TPP to be determined.

The determination condition (2-3): There is sufficient free space (number of unallocated chunks).

The determination condition (2-4): The user of the TPV to be determined as a migration destination permits the migration in advance.

The determination condition (2-2) is a condition for enabling determination as to the necessity of migration using an allocation required counter 134c, which will be described below. The determination condition (2-3) is a condition indicating that the capacity of the migration destination TPP will not be depleted even after migration, and is satisfied in a case where, for example, the free space of the migration destination TPP is equal to or greater than the capacity of the TPV to be determined. The determination condition (2-4) is determined based on, for example, preset information.

In a case where there are other TPPs that satisfy all the above determination conditions (2-1) to (2-4), the thin provisioning control unit 142 selects the TPP with the chunk size closest to the chunk size of the migration source TPP (for example, the TPP with the largest chunk size) as the migration destination candidate TPP.

Next, the thin provisioning control unit 142 determines the allocation status of chunks and the write status of data to the TPV to be determined using the allocation required counter 134c.

In this processing, first, the thin provisioning control unit 142 divides the logical storage area of the TPV to be determined for each chunk size of the migration destination candidate TPP. Unlike the case of FIG. 8, the length of the divided area is smaller than the chunk size of the migration source TPP. Therefore, in the following description, the divided area will be referred to as a “partial chunk section”. For example, in a case where the chunk size of the migration destination candidate TPP is ⅓ of the chunk size of the source TPP, each partial chunk section also has a length of ⅓ of the chunk size of the migration source TPP.

As an example in FIG. 9, chunks are allocated from TPP#10 with the chunk size of 42 MB to TPV#10 to be determined. Furthermore, it is assumed that TPP#12 with the chunk size of 21 MB is selected as the migration destination candidate TPP for such a migration source TPP#10. Since the chunk size of TPP#12 as the migration destination candidate is ½ of the chunk size of TPP#10 as the migration source, the partial chunk section over TPV#10 has the length of ½ of the chunk size of TPP#10 as the migration source.

Next, the thin provisioning control unit 142 determines whether to count up the allocation required counter 134c for each partial chunk section of the TPV to be determined. For example, the thin provisioning control unit 142 counts up the allocation required counter 134c in a case where a chunk is allocated from the migration source TPP to the partial chunk section, and valid data is included in the partial chunk section in the chunk.

In the present embodiment, 0 data is written to the entire unallocated chunk included in the TPP. Then, in a case where the unallocated chunk is allocated to the TPV and data is written to part of the chunk, 0 data remains in the remaining area of the chunk. Further, for example, in a case where data is written in only some of blocks in the allocated chunk, each of the remaining blocks is a block having 0 data written entirely (block with 0 data). The “block” referred to here is an area of the minimum unit of write I/O from the host server 200 to the TPV. Furthermore, in the following description, a block in which valid data is written is referred to as a “non-0 data block”.

Therefore, in a case where a chunk is allocated to the partial chunk section, and in a case where one or more non-0 data blocks are present in the partial chunk section in the chunk, the thin provisioning control unit 142 counts up the allocation required counter 134c.

In the example of FIG. 9, one chunk is allocated to partial chunk sections 161 and 162, and the blocks included in the partial chunk section 161 in this chunk are all 0 data blocks. Meanwhile, the partial chunk section 162 in this chunk contains non-0 data blocks. In this case, the allocation required counter 134c in the partial chunk section 162 is counted up.

Furthermore, one chunk is allocated to partial chunk sections 163 and 164, and the blocks included in the partial chunk section 164 in this chunk are all 0 data blocks. Meanwhile, the partial chunk section 163 in this chunk contains non-0 data blocks. In this case, the allocation required counter 134c in the partial chunk section 163 is counted up.

Furthermore, one chunk is allocated to partial chunk sections 165 and 166, and both areas of the partial chunk sections 165 and 166 in this chunk contain only 0 data blocks. In this case, the allocation required counter 134c is not counted up.

The count value of the allocation required counter 134c counted by the above procedure indicates the number of chunks allocated from the migration destination candidate TPP to the TPV to be determined in a case where migration is performed to the migration destination candidate TPP.

Next, the thin provisioning control unit 142 compares the number of chunks (the number of allocated chunks) allocated from the migration source TPP to the TPV to be determined with the number of chunks to be allocated from the migration destination candidate TPP in the case of performing migration, for example, the count value of the allocation required counter 134c. The thin provisioning control unit 142 calculates a ratio R2 of the latter number of chunks (count value) to the former number of allocated chunks. The ratio R2 is calculated using the following equation (2), where the number of allocated chunks is curr_alloc_cnt and the count value of the allocation required counter 134c is need_alloc_cnt.

R2[%]=need_alloc_cnt/curr_alloc_cnt×100 (2)

Since the chunk size of the migration destination candidate TPP is smaller than the chunk size of the migration source TPP, the ratio R2 is usually a value of 100% or more. Then, the lower the ratio R2, the more the increase in the number of chunks to be allocated to the TPV to be determined in the case where migration to the migration destination candidate TPP is performed is suppressed, and as a result, the increase in the capacity of the storage area for storing the management table is suppressed. Therefore, it is possible to improve the use efficiency (capacity efficiency) of the physical area while suppressing an increase in the capacity of the management table.

Therefore, in a case where the calculated ratio R2 is equal to or less than a predetermined threshold, the thin provisioning control unit 142 executes migration of the TPV to be determined to the migration destination candidate TPP as the migration destination. A value greater than 100% (for example, 110%) may be set as the threshold.

Note that, in the above processing, the ratio R2 of the count value of the allocation required counter 134c to the number of allocated chunks has been calculated. However, as another example, an increase amount (difference) of the allocation required counter 134c with respect to the number of allocated chunks may be calculated. In this case, the thin provisioning control unit 142 executes migration in a case where the increase amount is equal to or less than a predetermined threshold. Since the increase amount is usually a value of 0 or more, a value of 1 or more may be set as the threshold.

Furthermore, in the above processing, the TPP with the chunk size closest to the chunk size of the migration source TPP (the TPP with the largest chunk size) has been selected as the migration destination candidate TPP among other TPPs that satisfy all the determination conditions (2-1) to (2-4). However, another TPP with a smaller chunk size may be selected. Note that, in that case, the number of partial chunk sections increases, which tends to cause the allocation required counter 134c to count up. As a result, the TPV to be determined is less likely to be migrated to the TPP with a smaller chunk size.

Meanwhile, by selecting another TPP with the largest chunk size, it is possible to gradually migrate the TPV to the TPP with a smaller chunk size, and a chunk with a size suitable for the data write status of the TPV is allocated. As a result, it is possible to optimize balance between improvement of a use rate of the physical area and reduction of storage capacity of the management table.

Next, migration control processing by the thin provisioning control unit 142 will be described using flowcharts.

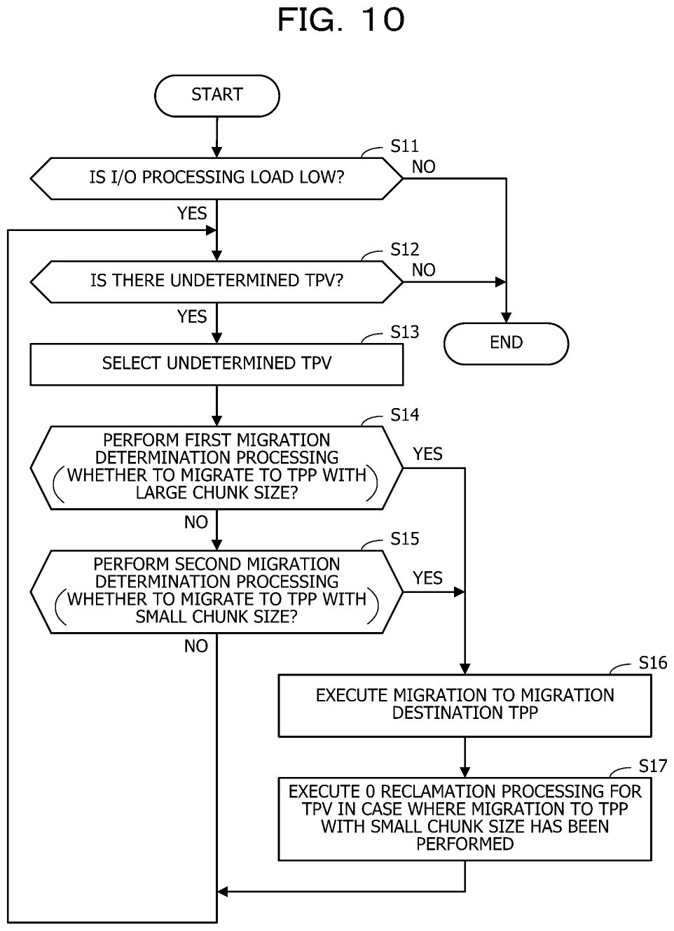

FIG. 10 is an example of a flowchart illustrating a procedure of migration control processing. The processing in FIG. 10 is executed, for example, at regular time intervals.

[step S11] The thin provisioning control unit 142 determines whether the load of I/O processing in the CM 110 in response to the request from the host server 200 is low. The I/O processing load is determined based on, for example, an index such as the use rate of the processor 111, and it is determined that the I/O processing load is low in a case where the index is equal to or less than a predetermined threshold. In a case where the I/O processing load is low, the process proceeds to step S12, or in a case where the I/O processing load is high, the migration control processing is terminated.

By the processing of step S11, the processing of step S12 and subsequent steps is executed in the state where the I/O processing load of the CM 110 is low. Note that, as another example, the processing of step S12 and subsequent steps may be executed at predetermined time at which the I/O processing load of the CM 110 is estimated to be low.

[step S12] The thin provisioning control unit 142 determines whether there is a TPV for which migration necessity has not been determined. In a case where there is an undetermined TPV, the processing proceeds to step S13, or in a case where migration necessity has been determined for all of TPVs, the migration control processing is terminated.

[step S13] The thin provisioning control unit 142 selects one of the TPVs for which migration necessity has not been determined as a TPV to be determined.

[step S14] The thin provisioning control unit 142 executes first migration determination processing for the TPV to be determined. This processing determines whether to migrate to the TPP with a larger chunk size. In a case where it is determined to migrate, the migration destination TPP is determined, and the processing proceeds to step S16. On the other hand, in a case where it is determined not to migrate, the processing proceeds to step S15.

[step S15] The thin provisioning control unit 142 executes second migration determination processing for the TPV to be determined. This processing determines whether to migrate to the TPP with a smaller chunk size. In a case where it is determined to migrate, the migration destination TPP is determined, and the processing proceeds to step S16. On the other hand, in a case where it is determined not to migrate, the processing proceeds to step S12.

[step S16] The thin provisioning control unit 142 executes migration to the determined migration destination TPP for the TPV to be determined.

[step S17] In a case where migration to the TPP with a smaller chunk size is performed in step S16 (in a case where it is determined as Yes in step S15), the thin provisioning control unit 142 executes 0 reclamation processing for the migrated TPP. As will be described below, the 0 reclamation processing is processing of releasing the allocated chunks containing only 0 data from the TPV.

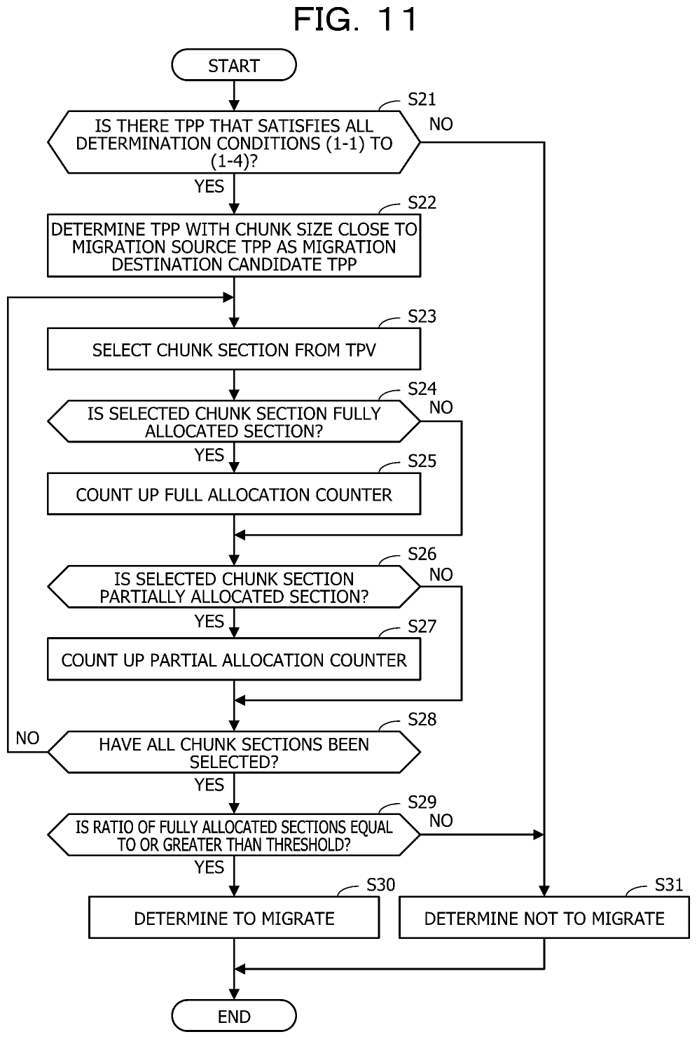

FIG. 11 is an example of a flowchart illustrating a procedure of the first migration determination processing. The processing in FIG. 11 corresponds to the processing in step S14 in FIG. 10.

[step S21] The thin provisioning control unit 142 determines whether there are TPPs that satisfy all the above-described determination conditions (1-1) to (1-4) in addition to the migration source TPP corresponding to the TPV to be determined. In a case where there are appropriate TPPs, the processing proceeds to step S22, or in a case where there are no appropriate TPPs, the processing proceeds to step S31.

[step S22] The thin provisioning control unit 142 determines the TPP with the chunk size close to the chunk size of the migration source TPP (the TPP with the smallest chunk size) as the migration destination candidate TPP from among the TPPs determined to satisfy all the determination conditions (1-1) to (1-4) in step S21. Furthermore, the thin provisioning control unit 142 resets each count value of the full allocation counter 134a and the partial allocation counter 134b to 0.

[step S23] The thin provisioning control unit 142 selects a head-side unselected chunk section from among the chunk sections obtained by dividing the TPV to be determined for each chunk size of the migration destination candidate TPP.

[step S24] The thin provisioning control unit 142 determines whether the selected chunk section is a “fully allocated section” that is a chunk section having the chunk allocated entirely from the migration source TPP. In a case where the chunk section is a fully allocated section, the processing proceeds to step S25, or in a case where the chunk section is not a fully allocated section, the processing proceeds to step S26.

[step S25] The thin provisioning control unit 142 counts up the full allocation counter 134a.

[step S26] The thin provisioning control unit 142 determines whether the selected chunk section is a “partially allocated section” that is a chunk section having the chunk only partially allocated from the migration source TPP. In a case where the chunk section is a partially allocated section, the processing proceeds to step S27, or in a case where the chunk section is not a partially allocated section, the processing proceeds to step S28.

[step S27] The thin provisioning control unit 142 counts up the partial allocation counter 134b.

[step S28] The thin provisioning control unit 142 determines whether all the chunk sections in the TPV to be determined have been selected. In a case where there are unselected chunk sections, the processing proceeds to step S23, and the head-side unselected chunk section is selected. On the other hand, in a case where all the chunk sections have been selected, the processing proceeds to step S29.

[step S29] The thin provisioning control unit 142 determines whether the ratio R1 of the fully allocated sections is equal to or greater than a predetermined threshold among the chunk sections to which one or more chunks are allocated from the migration source TPP included in the TPV to be determined. The ratio R1 is calculated using the above-described equation (1) based on each counter value of the full allocation counter 134a and the partial allocation counter 134b. In a case where the ratio R1 is equal to or greater than the threshold, the processing proceeds to step S30, or in a case where the ratio R1 is less than the threshold, the processing proceeds to step S31.

[step S30] The thin provisioning control unit 142 determines the migration destination candidate TPP as the migration destination TPP, and determines to migrate the TPV to be determined to the migration destination TPP.

[step S31] The thin provisioning control unit 142 determines not to migrate the TPV to be determined.

In the above processing, another TPP in which reduction in the capacity efficiency of the physical area is small and the storage capacity of the management table can be reduced in the case where migration is performed can be determined as the migration destination TPP.

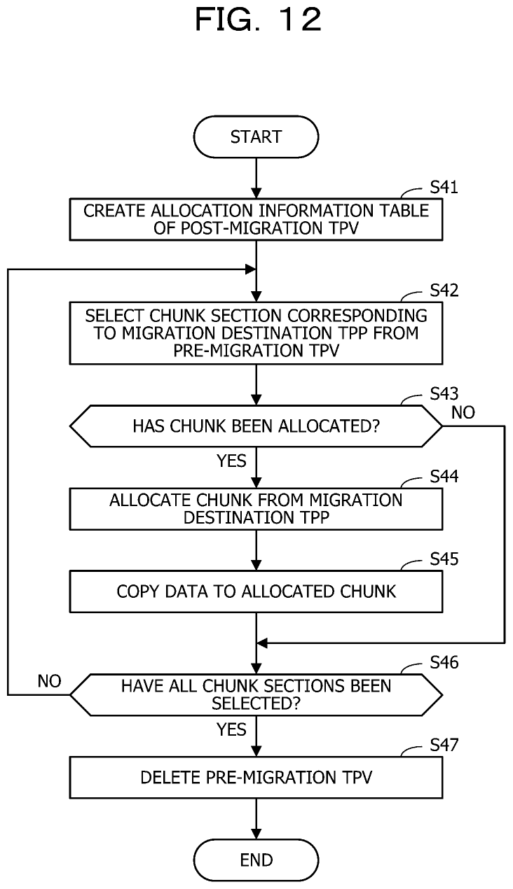

FIG. 12 is an example of a flowchart illustrating a procedure of migration processing to the TPP with a large chunk size. The processing of FIG. 12 corresponds to the processing of step S16 in the case where it is determined as Yes in step S14 of FIG. 10 (in the case where it is determined to migrate in step S30 of FIG. 11).

[step S41] The thin provisioning control unit 142 creates the allocation information table 133b corresponding to the TPV after migration (post-migration TPV). In the created allocation information table 133b, a record for each divided area obtained by dividing the logical storage area of the new TPV in units of the chunk size of the migration destination TPP is registered. Note that the capacity of the new TPV is the same as the capacity of the TPV before migration (pre-migration TPV).

[step S42] The thin provisioning control unit 142 selects one unselected chunk section corresponding to the migration destination TPP from the head side of the pre-migration TPV. As described above, the chunk section is a section obtained by dividing the pre-migration TPV for each chunk size of the migration destination TPP, and has a length that is a multiple of the chunk size of the migration source TPP.

[step S43] The thin provisioning control unit 142 determines whether one or more chunks are allocated from the migration source TPP to the selected chunk section. In a case where one or more chunks are allocated, the processing proceeds to step S44, or in a case where no chunks are allocated, the processing proceeds to step S46.

[step S44] The thin provisioning control unit 142 allocates chunks from the migration destination TPP to the area corresponding to the chunk section in the post-migration TPV. At this time, a record describing a relationship between the allocated chunk and the allocation destination area in the post-migration TPV is registered in the mapping table 133a corresponding to the migration destination TPP. Furthermore, the table address indicating the record registered in the mapping table 133a is registered in the appropriate record of the allocation information table 133b created in step S41.

[step S45] The thin provisioning control unit 142 copies the data of the chunk allocated to the selected chunk section in the pre-migration TPV to the chunk allocated to the post-migration TPV from the migration destination TPP in step S44. At this time, the data is copied such that the logical addresses in the TPVs become the same before and after copying.

[step S46] The thin provisioning control unit 142 determines whether all the chunk sections in the pre-migration TPV have been selected. In a case where there are unselected chunk sections, the processing proceeds to step S42, and an unselected chunk section is selected from the head side of the pre-migration TPV. On the other hand, in a case where all the chunk sections have been selected, the processing proceeds to step S47.

[step S47] The thin provisioning control unit 142 switches the access destination from the host server 200 from the pre-migration TPV to the post-migration TPV. Then, the thin provisioning control unit 142 deletes the pre-migration TPV. For example, the thin provisioning control unit 142 releases the chunk allocated to the pre-migration TPV from the migration source TPP, and deletes the TPV configuration information corresponding to the pre-migration TPV and the record of the allocation information table 133b. 0 data is written in the entire released chunk.

Note that the above-described migration processing can be executed while continuing the I/O processing of the TPV in response to the request from the host server 200. For example, the thin provisioning control unit 142 switches the access destination of the selected chunk section in the TPV from the pre-migration TPV to the post-migration TPV each time executing the processing of steps S42 to S45. In this case, the chunks allocated to the pre-migration TPV may be released at the point of time when the data copy in step S45 is completed.

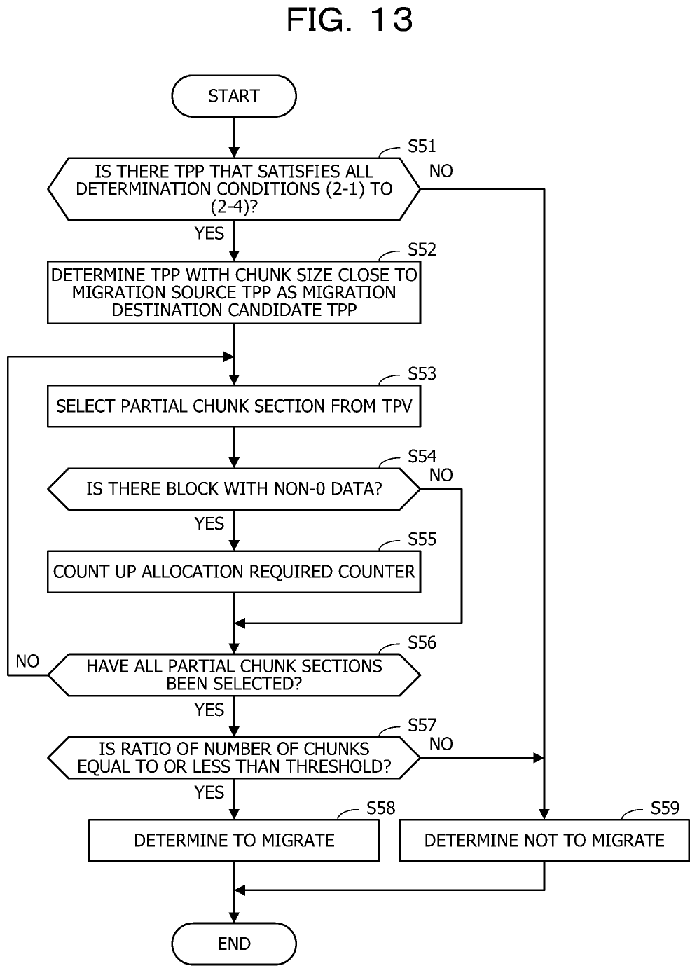

FIG. 13 is an example of a flowchart illustrating a procedure of the second migration determination processing. The processing in FIG. 11 corresponds to the processing in step S15 in FIG. 10.

[step S51] The thin provisioning control unit 142 determines whether there are TPPs that satisfy all the above-described determination conditions (2-1) to (2-4) in addition to the migration source TPP corresponding to the TPV to be determined. In a case where there are appropriate TPPs, the processing proceeds to step S52, or in a case where there are no appropriate TPPs, the processing proceeds to step S59.

[step S52] The thin provisioning control unit 142 determines the TPP with the chunk size close to the chunk size of the migration source TPP (the TPP with the largest chunk size) as the migration destination candidate TPP from among the TPPs determined to satisfy all the determination conditions (2-1) to (2-4) in step S51. Furthermore, the thin provisioning control unit 142 resets the count value of the allocation required counter 134c to 0.

[step S53] The thin provisioning control unit 142 selects a head-side unselected partial chunk section from among the partial chunk sections obtained by dividing the TPV to be determined for each chunk size of the migration destination candidate TPP.

[step S54] The thin provisioning control unit 142 determines whether a chunk is allocated to the selected partial chunk section from the migration source TPP, and whether non-0 data block is included in the partial chunk section in the chunk (whether valid data is included). In a case where the partial chunk section satisfies the above condition, the processing proceeds to step S55, or in a case where the above condition is not satisfied, for example, in a case where the entire chunk section is a 0 data block, the processing proceeds to step S56.

[step S55] The thin provisioning control unit 142 counts up the allocation required counter 134c.

[step S56] The thin provisioning control unit 142 determines whether all the partial chunk sections in the TPV to be determined have been selected. In a case where there are unselected partial chunk sections, the processing proceeds to step S53, and the head-side unselected partial chunk section is selected. On the other hand, in a case where all the partial chunk sections have been selected, the processing proceeds to step S57.

[step S57] The thin provisioning control unit 142 calculates the ratio R2 of the number of chunks allocated from the migration destination TPP (the count value of the allocation required counter 134c) to the number of allocated chunks to the TPV to be determined, using the above-described equation (2). The thin provisioning control unit 142 determines whether the calculated ratio R2 is equal to or less than a predetermined threshold. In a case where the ratio R2 is equal to or less than the threshold, the processing proceeds to step S58, or in a case where the ratio R2 is greater than the threshold, the processing proceeds to step S59.

[step S58] The thin provisioning control unit 142 determines the migration destination candidate TPP as the migration destination TPP, and determines to migrate the TPV to be determined to the migration destination TPP.

[step S59] The thin provisioning control unit 142 determines not to migrate the TPV to be determined.

In the above processing, another TPP in which an increase in the storage capacity of the management table is small, and the capacity efficiency of the physical area can be improved in the case where migration is performed can be determined as the migration destination TPP.

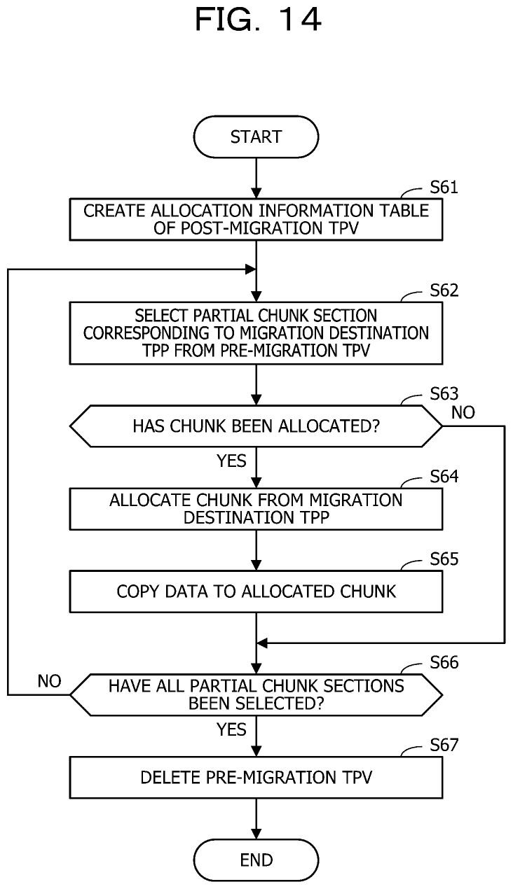

FIG. 14 is an example of a flowchart illustrating a procedure of migration processing to the TPP with a small chunk size. The processing of FIG. 14 corresponds to the processing of step S16 in the case where it is determined as Yes in step S15 of FIG. 10.

[step S61] The thin provisioning control unit 142 creates the allocation information table 133b corresponding to the TPV after migration (post-migration TPV). In the created allocation information table 133b, a record for each divided area obtained by dividing the logical storage area of the new TPV in units of the chunk size of the migration destination TPP is registered. Note that the capacity of the new TPV is the same as the capacity of the TPV before migration (pre-migration TPV).

[step S62] The thin provisioning control unit 142 selects one unselected partial chunk section corresponding to the migration destination TPP from the head side of the pre-migration TPV. As described above, the partial chunk section is a section obtained by dividing the pre-migration TPV for each chunk size of the migration destination TPP. The chunk size of the migration destination TPP is a multiple of the length of the partial chunk section.

[step S63] The thin provisioning control unit 142 determines whether a chunk is allocated from the migration source TPP to the selected partial chunk section. In a case where a chunk is allocated, the processing proceeds to step S64, or in a case where no chunk is allocated, the processing proceeds to step S66.

[step S64] The thin provisioning control unit 142 allocates the chunk from the migration destination TPP to the area corresponding to the partial chunk section in the post-migration TPV. At this time, a record describing a relationship between the allocated chunk and the allocation destination area in the post-migration TPV is registered in the mapping table 133a corresponding to the migration destination TPP. Furthermore, the table address indicating the record registered in the mapping table 133a is registered in the appropriate record of the allocation information table 133b created in step S61.

[step S65] The thin provisioning control unit 142 copies the data of the area corresponding to the selected partial chunk section, of the area of the chunk allocated to the selected partial chunk section in the pre-migration TPV, to the chunk allocated to the post-migration TPV from the migration destination TPP in step S64.

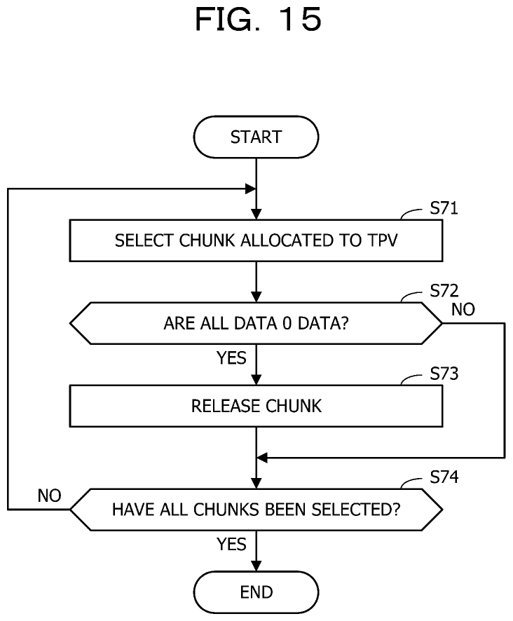

Here, as an example, for the purpose of simplifying the processing, copying is executed even in a case where all the data in the appropriate area are 0 data. Note that, in the case where all the data in the appropriate area are 0 data, steps S64 and S65 may be skipped and chunk allocation and data copying may not be executed. In this case, the subsequent 0 reclamation processing illustrated in FIG. 15 becomes unneeded.

[step S66] The thin provisioning control unit 142 determines whether all the partial chunk sections in the pre-migration TPV have been selected. In a case where there are unselected partial chunk sections, the processing proceeds to step S62, and an unselected partial chunk section is selected from the head side of the pre-migration TPV. On the other hand, in a case where all the partial chunk sections have been selected, the processing proceeds to step S67.

[step S67] The thin provisioning control unit 142 switches the access destination from the host server 200 from the pre-migration TPV to the post-migration TPV. Then, the thin provisioning control unit 142 deletes the pre-migration TPV. For example, the thin provisioning control unit 142 releases the chunk allocated to the pre-migration TPV from the migration source TPP, and deletes the TPV configuration information corresponding to the pre-migration TPV and the record of the allocation information table 133b. 0 data is written in the entire released chunk.

Note that the above-described migration processing can be executed while continuing the I/O processing of the TPV in response to the request from the host server 200, similarly to the case of FIG. 12. For example, the thin provisioning control unit 142 switches the access destination of the selected chunk section in the TPV from the pre-migration TPV to the post-migration TPV each time executing the processing of steps S62 to S65. In this case, the chunk allocated to the pre-migration TPV may be released at the point of time when all the data (including the 0 data) in the chunk is copied in step S65.

FIG. 15 is a flowchart illustrating a procedure of 0 reclamation processing. The processing in FIG. 15 corresponds to the processing in step S17 in FIG. 10.

In step S65 of FIG. 14, the data is copied as it is between the chunks of the migration source TPP and the migration destination TPP even if all the data in the area corresponding to the partial chunk section, of the area of the allocated chunks, are 0 data. Therefore, at predetermined timing after the migration processing in FIG. 14 is completed, 0 reclamation processing is executed to release chunks containing only 0 data among the chunks allocated from the migration destination TPP.

[step S71] The thin provisioning control unit 142 selects one chunk allocated to the migrated TPV.

[step S72] The thin provisioning control unit 142 determines whether all the data stored in the selected chunk are 0 data. In a case where all the data are 0 data, the processing proceeds to step S73, or in a case where data other than 0 data (valid data) is contained, the processing proceeds to step S74.

[step S73] The thin provisioning control unit 142 releases the allocated chunk. At this time, the record corresponding to the released chunk is deleted from the mapping table 133a corresponding to the migration destination TPP, and the table address is updated to an invalid value in the record of the allocation information table 133b that refers to this record.

[step S74] The thin provisioning control unit 142 determines whether all the chunks have been selected or not. If NO, the processing returns to step S71. If YES, the processing is ended.

Note that the processing functions of the devices described in each of the above embodiments (for example, the storage device 1, the CM 110, and the host server 200) can be implemented by a computer. In that case, a program describing the processing content of the functions to be held by each device is provided, and the processing functions described above are implemented on the computer by execution of the program on the computer. The program describing the processing content may be recorded in a computer-readable recording medium. Examples of the computer-readable recording medium include a magnetic storage device, an optical disk, a semiconductor memory, and the like. Examples of the magnetic storage device include a hard disk drive (HDD), a magnetic tape, and the like. The optical disk includes a compact disk (CD), a digital versatile disk (DVD), a Blu-ray disk (BD, registered trademark), or the like.

In a case where the program is to be distributed, for example, portable recording media such as DVDs and CDs, in which the program is recorded, are sold. Furthermore, it is also possible to store the program in a storage device of a server computer and transfer the program from the server computer to another computer via a network.

The computer that executes the program stores, for example, the program recorded on the portable recording medium or the program transferred from the server computer in its own storage device. Then, the computer reads the program from its own storage device, and executes processing according to the program. Note that the computer may read the program directly from the portable recording medium and execute the processing according to the program. Furthermore, the computer may sequentially execute processing according to the received program each time the program is transferred from the server computer coupled via the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage device comprising:
a storage in which a first pool area that provides a physical storage area in units of first chunks of a first size, and a second pool area that provides a physical storage area in units of second chunks of a second size smaller than the first size are set; and
a controller including a processor configured to
count a first count value that indicates a number of first divided areas in which data is stored from among a plurality of the first divided areas obtained by dividing, for the each second size, a virtual volume that has the first chunk allocated only to an area in which data is stored from the first pool area, and
in a case where a ratio or an increase amount of the first count value to a number of the first chunks allocated to the virtual volume is equal to or less than a first threshold,
allocate the second chunk from the second pool area instead of the first chunk to the virtual volume and
move the data of the first chunk allocated to the virtual volume to the second chunk allocated to the virtual volume.

2. The storage device according to claim 1, wherein
the first size is a multiple of the second size.

3. The storage device according to claim 1, wherein,
in the storage, a third pool area that provides a physical storage area in units of third chunks of a third size larger than the first size is further set, and
the processor is further configured to
count a second count value that indicates a number of second divided areas each has the first chunks allocated entirely to the second divided area, and a third count value that indicates a number of second divided areas each has the first chunk allocated only to part of the second divided area, from among a plurality of the second divided areas obtained by dividing the virtual volume for each third size,
in a case where a ratio of the second count value to a total value of the second count value and the third count value is equal to or greater than a second threshold,
allocate the third chunk from the third pool area instead of the first chunk to the virtual volume, and
move the data of the first chunk allocated to the virtual volume to the third chunk allocated to the virtual volume.

4. The storage device according to claim 3, wherein
the third size is a multiple of the first size.

5. A storage control method performed by a computer comprising a storage in which a first pool area that provides a physical storage area in units of first chunks of a first size, and a second pool area that provides a physical storage area in units of second chunks of a second size smaller than the first size are set, the method comprising steps of;
counting a first count value that indicates a number of first divided areas in which data is stored from among a plurality of the first divided areas obtained by dividing, for the each second size, a virtual volume that has the first chunk allocated only to an area in which data is stored from the first pool area, and
in a case where a ratio or an increase amount of the first count value to a number of the first chunks allocated to the virtual volume is equal to or less than a first threshold,
allocating the second chunk from the second pool area instead of the first chunk to the virtual volume and
moving the data of the first chunk allocated to the virtual volume to the second chunk allocated to the virtual volume.

6. A non-transitory computer readable recording medium storing a storage control program that causes a computer, comprising a storage in which a first pool area that provides a physical storage area in units of first chunks of a first size, and a second pool area that provides a physical storage area in units of second chunks of a second size smaller than the first size are set, to perform steps of;
counting a first count value that indicates a number of first divided areas in which data is stored from among a plurality of the first divided areas obtained by dividing, for the each second size, a virtual volume that has the first chunk allocated only to an area in which data is stored from the first pool area, and
in a case where a ratio or an increase amount of the first count value to a number of the first chunks allocated to the virtual volume is equal to or less than a first threshold,
allocating the second chunk from the second pool area instead of the first chunk to the virtual volume and
moving the data of the first chunk allocated to the virtual volume to the second chunk allocated to the virtual volume.
